(19) United States
(12) Patent Application Publication
(10) Pub. No.: US 2011/0020601 A1
(43) Pub. Date: Jan. 27, 2011

(54) METHOD FOR MAKING A SOLAR PLATE

(75) Inventor: Dominique Lutz, Creil (FR)

Correspondence Address: Osler, Hoskin & Harcourt LLP (JurisPatent), 1000 de La Gauchetiere Street West, Suite 2100, Montreal, QC, H3B 4W5, CA

(73) Assignee: HELIOSCREEN COSMETIC SCIENCE, Marseille (FR)

(21) Appl. No.: 12/809,971

(22) PCT Filed: Dec. 19, 2008
(86) PCT No.: PCT/FR08/01799

§ 371 Date: Aug. 17, 2010

(30) Foreign Application Priority Data
Dec. 21, 2007 (FR) 07/08972

(51) Int. Cl. B32B 3/26; B29C 41/42

(52) U.S. Cl. 428/141; 264/334

(57) ABSTRACT

The invention relates to a method for making a measurement substrate plate for the in vitro spectrophotometry testing of a cosmetic product including anti-UV filters, wherein said method comprises the following steps: using a mould with a textured bottom reproducing in a hollow form a predetermined topography; injecting into said mould a material that is transparent to UVA and UVB rays in order to form by moulding a preform of the measurement substrate plate; and releasing the measurement substrate plate thus obtained. The invention also relates to the measurement substrate plate obtained by said method.

The present invention relates to a method for manufacturing a measurement substrate plate for the in vitro spectrophotometry testing of a cosmetic product containing anti-UV filters. It also relates to a measurement substrate plate.

The sun necessary for terrestrial life and beneficial for the morale of everyone of us, nevertheless poses a problem of public health for persons who expose themselves to it in a too prolonged way and who accordingly are subject to burns or even to skin cancers.

Solar protection products (creams, ointments, milks) have therefore been developed for protecting the skin against aggressions from solar radiations.

In order to guide the consumer, indications relating to solar protection are inscribed on these products. Two indexes are defined: the solar protection factor against UVB radiations (SPF) and the protection factor against UVA radiation (persistent pigment darkening (PPD)).

In order to determine the solar protection factor of a product, presently in vivo test methods are mainly used.

This includes a certain number of drawbacks.

First of all, the tests are difficult to carry out during the summer months, because the subjects should not have a sun-tanned skin. They should be made on a certain number of subjects (about 10 or 20 persons) considering the different reactivity of each of them depending on their skin type. These tests are further expensive (subjects are paid) and require a long delay for conducting them. Finally, they pose an ethical problem since the subjects are partly irradiated by UV rays which are applied on them.

For this reason, one has recently resorted to in vitro tests.

The latter consist of measuring the absorption (or transmission) spectrum of a UV-transparent substrate on which a layer of a solar protection product has been applied. In order to allow spreading and retention of the product, the substrate has to be textured on the spreading face with roughness defined beforehand, on which the spread amount will depend. Reproducibility and therefore reliability of the measurement will depend on the quality of the topography and more particularly on its regularity.

This texturing is generally carried out by sanding the surface of the measurement substrate plate. This solution is not quite satisfactory since it does not properly provide reproducibility from one measurement substrate plate to another and therefore does not allow a valid comparison of different solar protection products or even obtaining a reproducible measurement on the same product.

The object of the invention is to find a remedy to this drawback.

For this purpose, the object of the invention is a method for manufacturing a measurement substrate plate for an in vitro test of a solar protection product, said method comprising the following steps:
using a mold with a textured bottom reproducing in a hollow form a predetermined topography, and notably a regular topography with a groove depth defined to within one micron,
injecting into said mold a material which is transparent to UVA and UVB rays in order to form by molding a preform of the measurement substrate plate, and
releasing the obtained measurement substrate plate from the mold.

The structure of the mold preferably has a regular structure, for example with regular grooves.

Preferably, the texture of the mold produces measurement substrate plates with a roughness defined by an arithmetic mean (Sa) comprised between two and twelve micrometers to within ±one micrometer, and more preferably for values of two or six micrometers.

According to an embodiment, the mold has a rectangular bottom and includes an injector in an angle.

Advantageously, the injected material is thermoplastic material which does not absorb UV, but is notably selected from those forming after polymerization a PMMA, a polycarbonate or polystyrene.

According to a particular embodiment, the non-textured face of the preform is polished.

Advantageously, a mold is used for which the texture is obtained by one of the following techniques: microbeading, sanding or spark-erosion.

The object of the invention is also a measurement substrate plate obtained by the method according to the invention. According to a particular embodiment, the measurement substrate plate is rectangular or square, preferably square, the sides having a length comprised between 25 and 100 mm or between 50 and 100 mm, more particularly between 25 and 80 mm.

The invention will be better understood in the light of the description which follows, given as an illustration and not as a limitation, with reference to the appended drawings wherein:

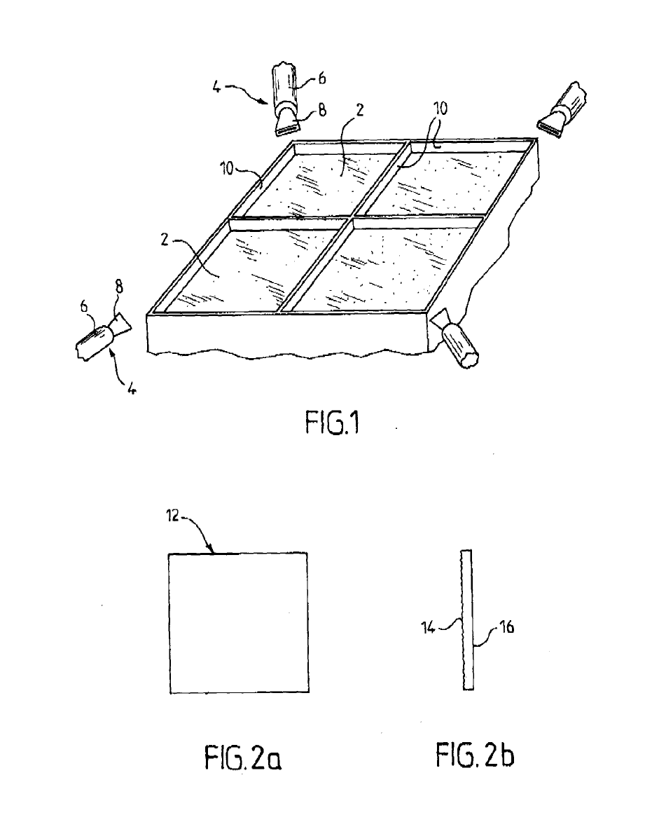

FIG. 1 illustrates an embodiment of a mold with four imprints in order to form four substrate plates, and

FIGS. 2a and 2b illustrate in a front view and a side view, a substrate plate obtained by the method according to the invention.

In FIG. 1 a mold is illustrated for manufacturing substrate plates according to the invention. In the illustrated example, the mold includes four imprints 2 in order to each make a substrate plate. The imprints are dimensioned in order to form square solar plates with a side of 50 mm, but other dimensions or shapes are of course possible.

The mold is part of an apparatus including a source of material for the measurement substrate plates and, for each imprint, an injection nozzle 4 comprising a supply channel 6 and a side lap of the “swallowtail” type 8.

After injection of the material into the mold, a planar countermold is applied on the mold in order to form a planar face of the plate.

In order to facilitate the release of the plates, the edges 10 of the imprints of the mold are preferably slightly tilted, for example by an angle of a few degrees, such as 4° relatively to the vertical, and towards the outside of each imprint.

For the material to be injected, a material is selected which is as transparent as possible to UVA and UVB, so that UV radiation passing through the solar product to be tested, applied as a layer on the plate, and the plate itself does not totally absorb the latter. Preferably, the material is selected from those which are the most UV-transparent.

As an example, the materials to be injected which are presently considered as being particularly of interest, comprise those which form after polymerization polymethyl methacrylate (PMMA), polycarbonate or polystyrene. Other materials such as those forming after polymerization polypropylene, although not excluded, are less preferred because their hydrophobic properties are not suitable for many cosmetic formulations of solar products to be tested.

The mold is made in order to reproduce in hollow form a regular topography. This may be obtained by any known means, and notably by sanding, microbeading or spark-erosion. The latter technique is presently preferred because it leads to better quality of the obtained graining (texturing). The texturing is for example in the range from 2±1 to 14±1 μm and notably in the range from 2 to 10 μm.

The textured face of the plate obtained by injection is the face intended to receive a fine layer of the solar product to be tested.

The other face of the plate is polished so as not to perturb the measurements of the UV absorption spectrum. This polishing may be carried out while the plates are still in the mold, the countermold being set aside, or after release from the mold.

An embodiment of a plate 12 obtained by the manufacturing method of the invention is illustrated in FIGS. 2a and 2b. This plate has a square shape with a side of 50 mm and a thickness of 1.5 mm. The face 14 intended to receive the solar product to be tested has roughness defined by an arithmetic mean comprised between two and fourteen micrometers to within ±one micrometer. The other face 16 is polished.

With the manufacturing method of the invention, it is possible to produce a series of homogenous plates, unlike with the methods according to the prior art. The tests of solar products are thereby reproducible under identical conditions and allow reliable comparisons under different conditions, for example of temperature, humidity or pressure.

Thus, a particularly interesting contribution of the invention consists of proposing sets of plates, for example as a batch or a box, from a same mold and for which, consequently, the results of tests carried out with these plates are directly comparable with each other.

1. A method for manufacturing a measurement substrate plate for an in vitro test of a solar protection product, said method comprising the following steps:
using a mold with a textured bottom reproducing in hollow form a predetermined topography,
injecting into said mold a material which is transparent to UVA and UVB rays in order to form by molding a preform of the measurement substrate plate, and
releasing the obtained measurement substrate plate from the mold.

2. The method according claim 1, wherein the mold has a rectangular bottom and includes an injector in an angle.

3. The method according to claim 1, wherein the injected material is thermoplastic material which does not absorb UVA and UVB rays.

4. The method according to claim 3, wherein the material is selected from those forming after polymerization, a PMMA, a polycarbonate or a polystyrene.

5. The method according to claim 1, wherein the non-textured face of the preform is polished.

6. The method according to claim 1, wherein a mold is used, the texture of which is obtained by one of the following techniques: microbeading, sanding or spark-erosion.

7. A measurement substrate plate obtained by the manufacturing method according to any of claims 1 to 6.

8. The measurement substrate plate according to claim 7, characterized in that it is rectangular, the sides having a length comprised between 25 and 80 mm.

9. The measurement substrate plate according to claim 8, characterized in that it has roughness defined by an arithmetic mean comprised between 2 and 14 micrometers to within ±1 micrometer.

10. The measurement substrate plate according to claim 7, characterized in that it has roughness defined by an arithmetic mean comprised between 2 and 14 micrometers to within ±1 micrometer.
